(19) United States
(12) Patent Application Publication
(10) Pub. No.: US 2026/0305674 A1
(43) Pub. Date: Oct. 8, 2026

(54) NON-INVASIVE BREADFRUIT ROASTER AND METHODS OF USING SAME TO EVENLY ROAST BREADFRUIT

(71) Applicant: Rupert Riley, Kingston (JM)

(72) Inventor: Rupert Riley, Kingston (JM)

(21) Appl. No.: 19/481,732

(22) PCT Filed: May 14, 2024
(86) PCT No.: PCT/US2024/029215

§ 371 Date: Nov. 5, 2025

Related U.S. Application Data
(60) Provisional application No. 63/503,056, filed on May 18, 2023.

(51) Int. Cl. A23N 12/10; A47J 37/04

(52) U.S. Cl. CPC A23N 12/10; A47J 37/041

(57) ABSTRACT

The present disclosure provides devices for evenly roasting breadfruit and similar produce without piercing the skin (e.g., the periphery) of the produce.

### PRIORITY CLAIM

This application claims priority to U.S. Provisional Patent Application Ser. No. 63/503,056, filed on May 18, 2023, the entire contents of which are incorporated herein by reference and relied upon.

### FIELD

The present disclosure provides devices and methods for evenly roasting produce, such as fruit, and especially multiple units of produce that may have similar or different overall sizes and shapes.

### BACKGROUND

Known techniques for roasting breadfruit (Artocarpus altilis) require constant supervision to prevent uneven roasting and frequently result in burnt areas, leading to loss of fruit, and lower quality of the breadfruit. These techniques are time-consuming and subject to operator skill. Improved methods and equipment for evenly roasting breadfruit are needed.

### SUMMARY

The present disclosure provides methods and devices for roasting produce (e.g., breadfruit, vegetables, fruit, yam, etc.) without requiring constant supervision by a user. Breadfruit is just one example of foodstuff that may be roasted using the methods and devices disclosed herein; however due to the spherical nature of the breadfruit, the breadfruit is a suitable representative example to describe and enable methods and devices consistent with the scope of this disclosure. In other examples, non-spherical fruit can be used. Devices and methods consistent with this disclosure evenly roast foodstuff, such as breadfruit, due at least in part to the rotation of rods supporting the periphery of the food item(s). In some embodiments, the fruit is supported during roasting without being pierced, for example by supporting the fruit around or at the periphery of the fruit.

In some embodiments, the present disclosure provides an apparatus for roasting a fruit having a periphery, the apparatus comprising: a first endplate and a second endplate; a first rod defining a first end and a second end, the first end of the first rod attached to the first endplate and the second end of the first rod attached to the second endplate; a second rod defining a third end and a fourth end, the third end of the second rod attached to the first endplate and the fourth end of the second rod attached to the second endplate; a third rod defining a fifth end and a sixth end, the fifth end of the third rod attached to the first endplate and the sixth end of the third rod attached to the second endplate; and a fourth rod defining a seventh end and an eighth end, the seventh end of the fourth rod attached to the first endplate and the eighth end of the fourth rod attached to the second endplate, wherein the endplates and rods are configured to support the fruit without piercing the periphery of the fruit.

In other embodiments, the present disclosure provides a method of roasting breadfruit, the method comprising: attaching a first end of a first rod to a first hole of a first endplate and a second end of the first rod to a first hole of a second endplate; attaching a first end of a second rod to a second hole of the first endplate and a second end of the second rod to a second hole of the second endplate; attaching a first end of a third rod to a third hole of the first endplate and a second end of the third rod to a third hole of the second endplate; attaching a first end of a fourth rod to a fourth hole of the first endplate and a second end of the fourth rod to a fourth hole of the second endplate; inserting one or more breadfruits between the rods; rotating the first and second endplates; and roasting the breadfruit.

In other embodiments, the present disclosure provides a cage for non-invasively supporting a fruit, the cage comprising: a first endplate including a first plurality of holes disposed equidistantly from the center point of the first endplate by a first distance; a second endplate including a second plurality of holes disposed equidistantly from the center point of the second endplate by the first distance; and a plurality of rods, each rod extending from one of the first plurality of holes in the first endplate to one of the second plurality of holes in the second endplate.

### BRIEF DESCRIPTION OF THE DRAWINGS

FIG. 1 shows a front view of a non-invasive fruit roaster with an open lid.

FIG. 2 shows a top view of a non-invasive fruit roaster with an open lid.

FIG. 3 shows a side view of a non-invasive fruit roaster with an open lid.

FIG. 4 shows an isometric view of a non-invasive fruit roaster with an open lid.

FIG. 5 shows a cross sectional view of a non-invasive fruit roaster with an open lid indicated in FIG. 1.

FIG. 6 shows a top view of a cage of a non-invasive fruit roaster.

FIG. 7 shows a cross section view indicated in FIG. 6 of a cage of a non-invasive fruit roaster with a gate in a closed configuration.

FIG. 8 shows a cross section view indicated in FIG. 6 of a cage of a non-invasive fruit roaster with a gate in an open configuration.

FIG. 9 shows a front view of a wedge for a non-invasive fruit roaster.

FIG. 10 shows a side view of a wedge for a non-invasive fruit roaster.

FIG. 11 shows a front view of a non-invasive fruit roaster that allows various heat sources.

FIG. 12 shows a top view of a non-invasive fruit roaster that allows various heat sources.

FIG. 13 shows a side view of an endplate and rods of a non-invasive fruit roaster with rods located on three diameters and four equally spaced angles.

FIG. 14 shows a side view of an endplate and rods of a non-invasive fruit roaster with rods located on three diameters and six equally spaced angles.

FIG. 15 shows a side view of an endplate and rods of a non-invasive fruit roaster with rods located on three diameters and six equally spaced angles and four rods located on two diameters and diametrically opposed.

FIG. 16 shows a side view of an endplate and rods of a non-invasive fruit roaster with rods located on five diameters and six equally spaces angles and eight rods located on four diameters and diametrically opposed.

FIG. 17 shows a front view of a wedge with a compressible support.

FIG. 18 shows a side view of a wedge with a compressible support.

FIG. 19 shows a side view of a tension spring.

FIG. 20 shows a side view of the cage depicted in FIG. 6.

FIG. 21 is a photograph showing a cage configured to support one or more fruits and for use with a toaster or rotisserie oven.

FIG. 22 is a photograph showing another view of the cage of FIG. 21.

FIG. 23 is a photograph showing an exterior view of the cage of FIG. 21.

FIG. 24 is a photograph showing an interior view of the cage of FIG. 21.

### DETAILED DESCRIPTION

In general, the present disclosure provides a non-invasive fruit roaster, and methods of using same to roast fruit. Non-invasive fruit roasting involves roasting fruit without breaching the outermost layer (e.g., skin or peel) of the fruit. Devices and methods for supporting the periphery of oddly shaped fruit and providing reliable and consistent movement of the fruit relative to a heat source are disclosed.

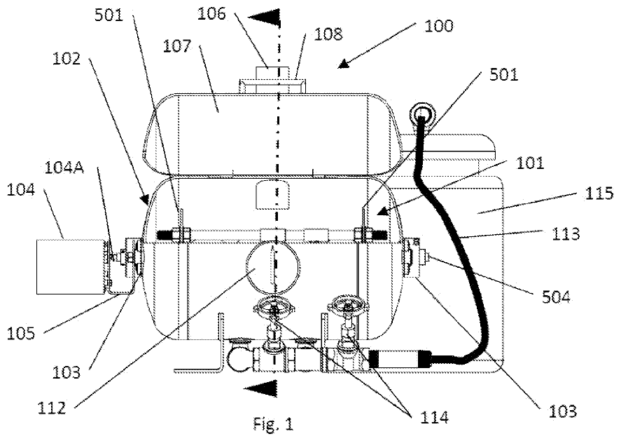

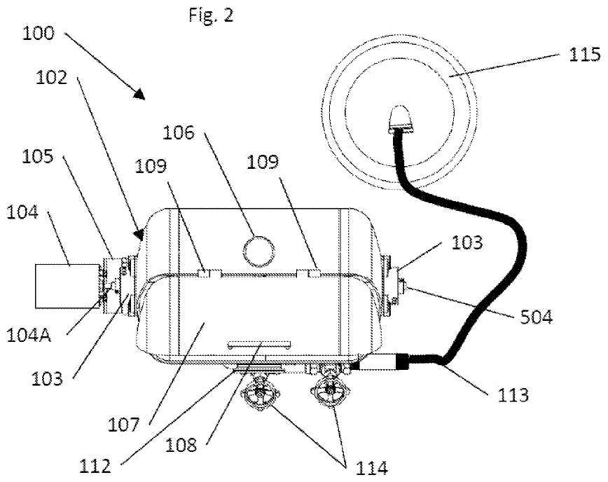

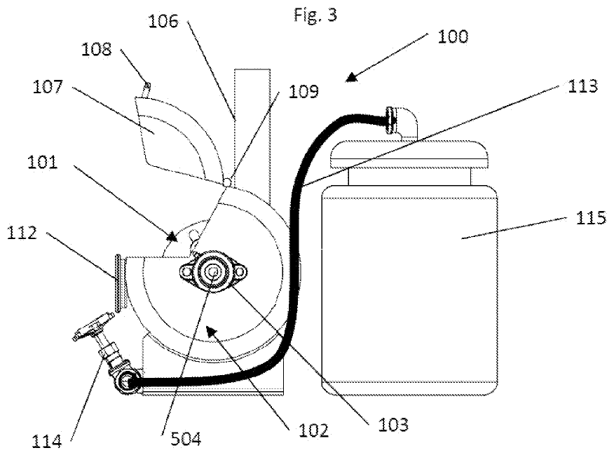

FIGS. 1-4 depict an example of a non-invasive roaster 100. The non-invasive roaster 100 includes an example cage 101 for supporting fruit on the fruit periphery, an example shell 102 and an example motor 104 may be attached to the example shell 102. Cage 101 is rotationally attached to shell 102 at each end by bearings 103. Motor bracket 105 supports motor 104 and is attached to shell 102.

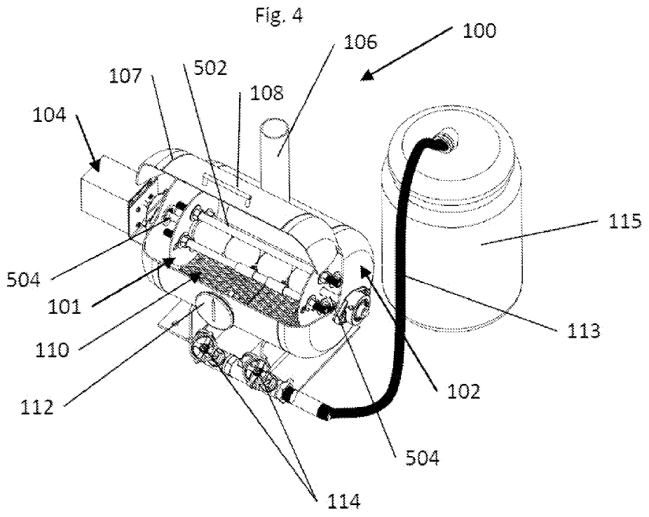

In some embodiments, motor bracket 105 may be attached directly to shell 102; in others, attachment to bearing 103 may be preferred. Motor 104 includes a motor shaft 104A (e.g., or a motor socket) which attaches to endplate spindle 504 (further described as shown in FIG. 4). Motor 104, when energized, rotates cage 101 about bearings 103. A plurality of fruits may be rotated without the need to constantly rotate the fruits manually to prevent burning and allowing even roasting. In some embodiments, the shell 102 has a generally cylindrical shape. In other embodiments, alternative shell 102 shapes may be utilized (e.g., square, hexagonal, triangular, etc.).

Shell 102 may include a lid 107 for providing access to the interior of shell 102. Lid 107 may include a handle 108 for pivoting the lid 107 about hinges 109. A steam vent 106 may be included to allow gases from a heat source and moisture from a roasting fruit to exit from shell 102. A burner 111 may be included and be positioned below the cage 101. In some embodiments, the burner 111 is supplied fuel from fuel tank 115 through fuel line 113. The flow rate of the fuel may be controlled with a valve 114. In some embodiments, multiple burners 111 may be used and controlled by individual values similar to the embodiments specifically shown in FIGS. 1, 2, 4, and 5. A thermometer 112 may be attached to the shell 102 to, for example, indicate the temperature inside the shell 102. In some embodiments, information provided by the thermometer 112 is used to control fuel flow to the burner 111 using the valve 114.

The shell 102 may include a mesh grille 110 disposed between the cage 101 and the burner 111. The mesh grille 110 may be included to prevent waste generated during roasting from affecting (e.g., impeding) the burner 111. In other embodiments, the mesh grille 110 holds wood and/or charcoal to be burned as a heat source instead of or in addition to the burner 111.

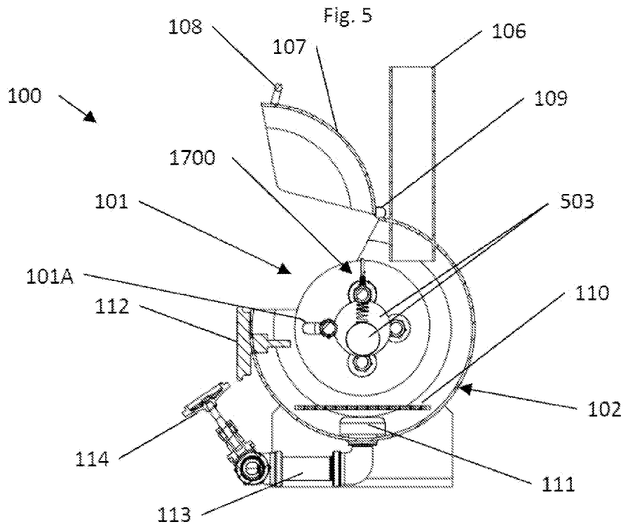

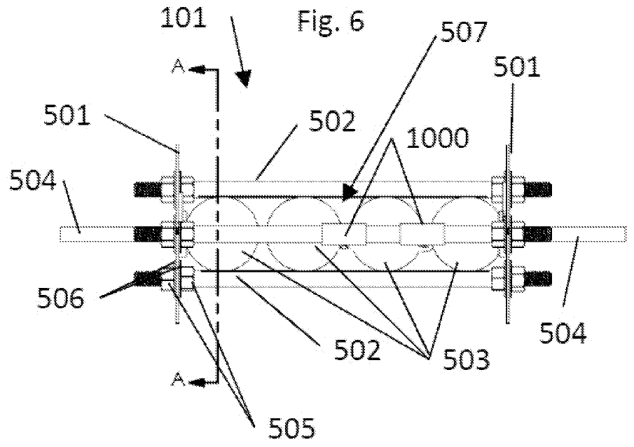

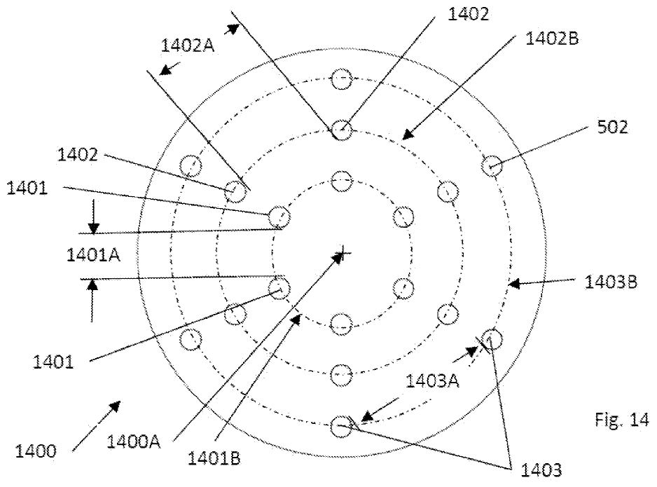

FIG. 6 depicts one embodiment of the cage 101. The cage 101 may include a pair of endplates 501 disposed at opposing ends of the cage 101. Rods 502 are attached to the endplates 501 and are used to support the periphery of fruit 503—in some embodiments the rods 502 contact the periphery of the fruit 503 but do not pierce the periphery of the fruit 503. For example and without limitation, in some embodiments the rods 502 exert force on the periphery of the fruit 503 towards a central axis of the cage 101 extending from the center point of one endplate 501 to the center point of the opposing endplate 501. In some embodiments, the rods 502 are disposed and arranged to lock (e.g., trap, keep, hold) the fruit 503 even as the fruit 503 shrinks during roasting. Rods 502 may be attached to endplates 501 by insertion of each end of each rod 502 into holes (FIGS. 14-16) in endplates 501 and secured with nuts 505 and washers 506. In some examples, endplates 501 may include slot 101A (best shown in FIG. 5) such that rod 502 may be adjusted depending on fruit 503 size. Any method of attaching rods 502 to endplates 501 may be used. Rods 502 and endplates 501 provide an interior space 507 for supporting the periphery of fruit 503. In some examples, rods 502 may be cylindrical or any another cross-sectional geometry such as rectangle, hexagonal, or triangular. Rod 502 only needs a periphery for supporting fruit and ends for attaching to endplates 501. The rods 502 may have any length sufficient to enable the cage 101 to accommodate one or more fruits 503, such as one fruit 503, two fruits 503, three fruits 503, four fruits 503, five fruits 503, or more than five fruits 503.

Spindles 504 are rotationally supported by bearings 103, and are configured to rotate cage 101 during roasting.

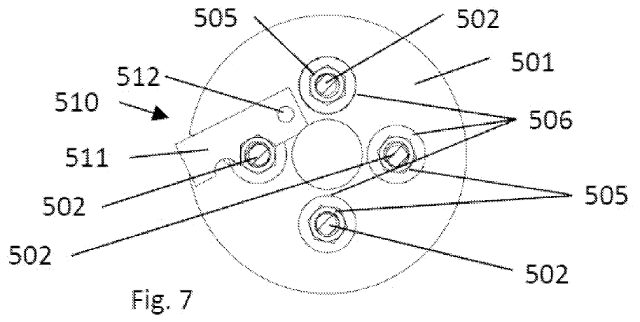

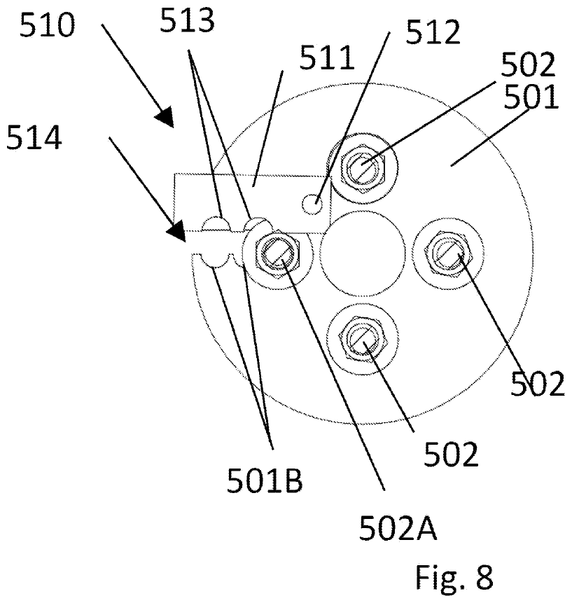

FIG. 6 depicts cage 101 with fruit supported in interior space 507. In some embodiments, the cage 101 may include features for inserting and removing fruit from the interior space 507. For example and without limitation, the cage 101 may include a gate device 510. FIG. 8 depicts the gate device 510 in an open configuration while FIG. 7 depicts the gate device 510 in a closed configuration. The gate device 510 allows access to interior space 507 for placing and removing fruit 503. The gate device 510 includes a gate 511 rotationally supported on endplate 501 by a gate shaft 512. Gate 511 may include notches 513 that engage rod 502A when the gate 511 is rotated about the gate shaft 512 as shown in FIG. 7. In some embodiments, the endplate 501 includes a slot 514 and may additionally include notches 501B configured to engage the rod 502A. The notches 513 and 501B support the rod 502A when the gate 511 is rotated about the gate shaft 512 as shown in FIG. 7. Any number of gate devices 510 may be disposed on any number of the rods 502A. The gate device 510 may include any number of notches 513 including zero. The gate device 510 are configured such that the rod 502A is restrained sufficiently to support fruit 503 during roasting (e.g., while the cage 101 is rotated). In some embodiments, a wedge 1000 may be disposed along one or more of the rods 502, 502A to retain fruit 503 from grouping together or to separate a plurality of fruit 503.

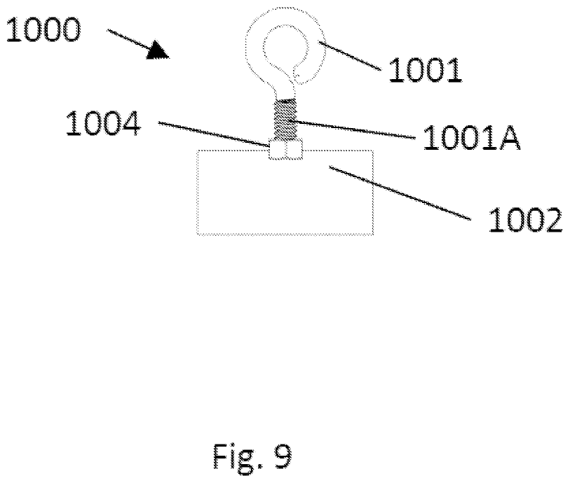

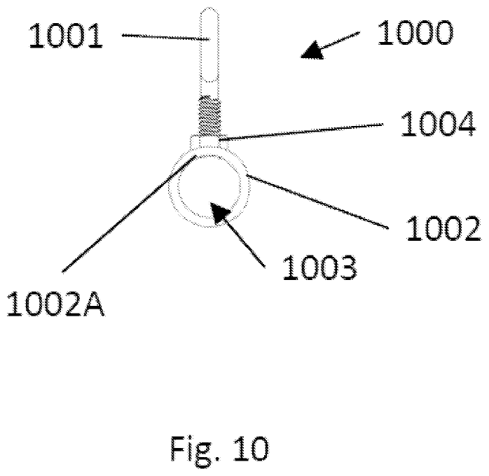

FIGS. 9 and 10 depict wedge 1000. In some embodiments, the wedge 1000 is configured to engage with (e.g., slide and clamp onto) rods 502 and or 502A. The wedge 1000 is generally configured to separate fruit from each other. Wedge 1000 may comprise an eyebolt 1001 attached to a tube 1002. In some embodiments, the eyebolt 1001 is mated with the tube 1002 by a threaded connection. In such embodiments, a thread feature 1001A on the eyebolt 1001 is screwed into a threaded hole 1002A disposed through one side of the tube 1002 and secured by a nut 1004. The tube 1002 may include a hole 1003 configured to receive the rod 502 such that the wedge 1000 can slide along rod 502. A user can slide and secure wedge 1000 at a desired location along the rod 502. The user secures the wedge 1000 in place by tightening the eyebolt 1001 such that the threaded feature 1001A contacts the rod 502. In other examples, the wedge 1000 may be comprised of any structure configured to be positioned on and fixed to the rod 502 to separate fruit 503. The wedge 1000 may alternatively be referred to as a “Kotch” or a “Stay.” One of skill in the art will recognize that other fasteners may be used to separate (e.g., prevent lateral movement of) the produce 503.

In some embodiments, the wedge 1000 is configured to engage with (e.g., slide and clamp onto) rods 502 and 502A to enable the cage 101 to accommodate fruits 503 of different relative sizes. In such configurations, the wedge 1000 is positioned along the rods 502 and/or 502A between the rod 502/502A and the portion of the fruit 503 closest to the rods 502/502A. In some embodiments, the wedge 1000 contacts the surface of the fruit 503 to, for example, exert a mild force on the exterior surface of the fruit 503.

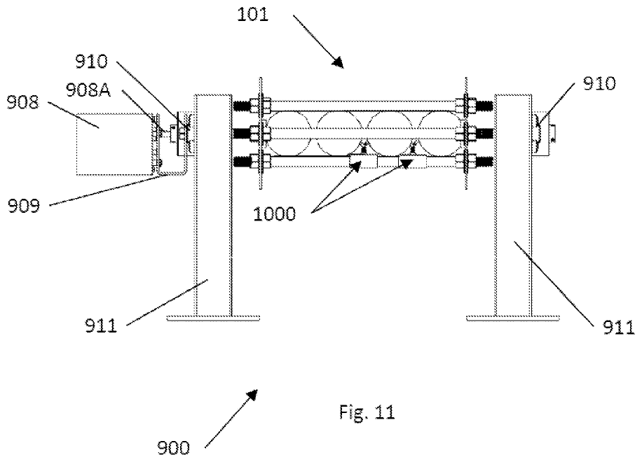

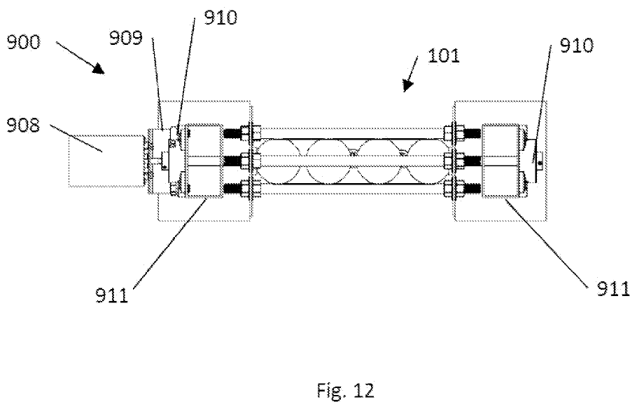

FIGS. 11 and 12 depict an embodiment wherein the non-invasive fruit roaster 900 supports and revolves fruit 503 and accommodates various heat sources. In some embodiments, a heating element (e.g., wood, charcoal, gas burners, electric element which radiates heat) may be used to roast the fruit 503. In some embodiments, the device 900 may include a cage 101, and a motor 908 attached to a support 911 by a motor bracket 909. The cage 101 may be rotationally supported by bearings 910 disposed at opposing ends. The bearings 910 may be supported by supports 911. In some embodiments, the device 900 includes multiple bearings 910 and supports 911; in other embodiments a single bearing 910 and support 911 may be present. The motor 908 may be attached to the support 911 by a motor mount 909. In some embodiments, the motor mount 909 is attached directly to the support 911; in other embodiments the motor mount is attached to the bearing 910 instead. The motor 908 includes a motor shaft 908A engaged with (e.g., connected to) the end of the endplate spindle 504. When energized, the motor 908 rotates the cage 101 about the bearings 910.

Using a non-invasive fruit roaster 900 consistent with the present disclosure provides operational features not available with previously known devices. For example, non-invasive fruit roasters 900 disclosed herein enable roasting using a variety of heat sources. For instance, an open flame could be used as the heat source, as well as a camp stove or a barbeque. Additionally, a user can easily assess the degree to which the fruit 503 has been roasted without opening the lid because the aroma of the roasting fruit is easily appreciated by the user during operation.

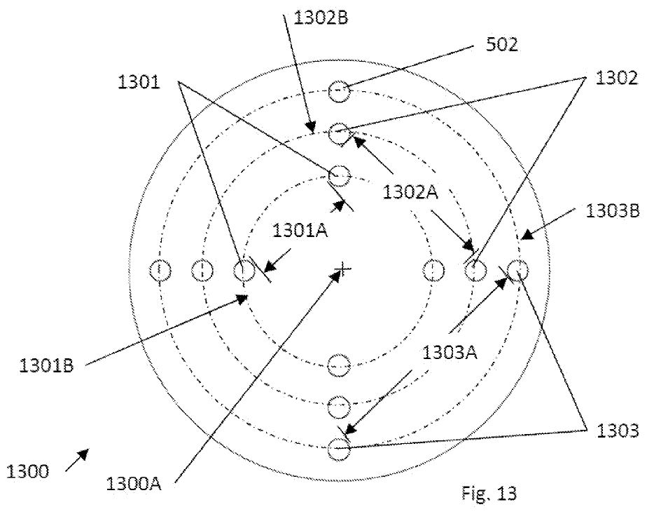

In addition, fruit 503 of different sizes can be supported in the cage 101 during roasting, for example by positioning or repositioning the rods 502 on the endplates 501. FIGS. 13-16 depict various embodiments of endplates 501. In general, endplates 501 are configured to enable rods 502 to be positioned based on the size of fruit 503 before and/or after roasting (e.g., to anticipate and accommodate contraction of the produce (e.g., from fluid loss) during the roasting process). FIG. 13 depicts endplate 1300 and four rod 502 locations 1301 spaced equally on circumference 1301B having equidistance from center point 1300A. Endplate 1300 may include four rod 502 locations 1302 spaced equally on circumference 1302B having equidistance from center point 1300A. Endplate 1300 may include four rod 502 locations 1303 spaced equally on circumference 1303B having equidistance from center point 1300A.

Rods 502 may be disposed on endplate 1300 at locations 1301 such that distance 1301A is established between rods 502. With rods 502 equally spaced from each other and from center point 1300A, a fruit 503 having a minimum width larger than distance 1301A will be well-supported by a cage 101 equipped with rods 502 disposed at locations 1301.

Rods 502 may be disposed on endplate 1300 at locations 1302 such that distance 1302A is established between rods 502. Rods 502 may be disposed on endplate 1300 at locations 1302 such that distance 1302A is established between rods 502. With rods 502 equally spaced from each other and from center point 1300A, a fruit 503 having a minimum width larger than distance 1302A will be well-supported by a cage 101 equipped with rods 502 disposed at locations 1302.

Rods 502 may be disposed on endplate 1300 at locations 1303 such that distance 1303A is established between rods 502. With rods 502 equally spaced from each other and from center point 1300A, a fruit 503 having a width larger than distance 1303A will be well-supported by a cage 101 equipped with rods 502 disposed at locations 1303.

FIG. 14 depicts endplate 1400 and six rod 502 locations 1401 spaced equally on circumference 1401B having equidistance from center point 1400A. Endplate 1400 may include six rod 502 locations 1402 spaced equally on circumference 1402B. Endplate 1400 may include six rod 502 locations 1403 spaced equally on circumference 1403B having equidistance from center point 1400A.

Rods 502 may be disposed on endplate 1400 at locations 1401 such that distance 1401A is established between rods 502. With rods 502 equally spaced from each other and from center point 1400A, a fruit 503 having a minimum width larger than distance 1401A will be well-supported by a cage 101 equipped with rods 502 disposed at locations 1401.

Rods 502 may be disposed on endplate 1400 at locations 1402 such that distance 1402A is established between rods 502. Rods 502 may be disposed on endplate at locations 1402 such that distance 1402A is established between rods 502. With rods 502 equally spaced from each other and from center point 1400A, a fruit 503 having a minimum width larger than distance 1402A will be well-supported by a cage 101 equipped with rods 502 disposed at locations 1402.

Rods 502 may be disposed on endplate 1400 at locations 1403 such that distance 1403A is established between rods 502. Rods 502 may be disposed on endplate at locations 1403 such that distance 1403A is established between rods 502. With rods 502 equally spaced from each other and from center point 1400A, a fruit 503 having a minimum width larger than distance 1403A will be well-supported by a cage 101 equipped with rods 502 disposed at locations 1403.

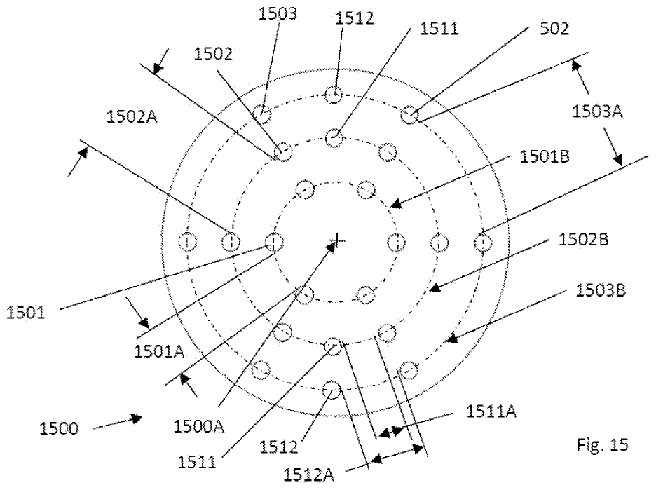

FIG. 15 depicts endplate 1500. Endplate 1500 may include six rod 502 locations equally spaced on various circumferences (e.g., 1501B) and may include additional rod 502 locations 1511, 1512 disposed on various circumferences (e.g., 1502B, 1503B) and separated from each other by 180 degrees.

Rods 502 may be disposed on endplate 1500 at locations 1501 such that distance 1501A is established between rods 502. With rods 502 equally spaced from each other and from center point 1500A, a fruit 503 having a minimum width larger than distance 1501A will be well-supported by a cage 101 equipped with rods 502 disposed at locations 1501.

Rods 502 may be disposed on endplate 1500 at locations 1502 such that distance 1502A is established between rods 502. Rods 502 may be disposed on endplate at locations 1502 such that distance 1502A is established between rods 502. With rods 502 equally from each other and from center point 1500A, a fruit having a minimum width larger than distance 1502A will be supported by a cage 101 including two endplates 1500 equipped with rods 502 disposed at locations 1502.

Rods 502 may be disposed on endplate 1500 at locations 1503 such that distance 1503A is established between rods 502. Rods 502 may be disposed on endplate at locations 1503 such that distance 1503A is established between rods 502. With rods 502 equally spaced from each other and from center point 1500A, a fruit 503 having a minimum width larger than distance 1503A will be well-supported by a cage 101 including two endplates 1500 equipped with rods 502 disposed at locations 1503.

In some embodiments, rods 502 are arranged on endplate 1500 irregularly—for example at one or more of locations 1511, 1512—such that the rods 502 are not all equally spaced from each other. In such embodiments, fruit 503 of irregular shape may be well-supported by a cage 101 including two endplates 1500 and a plurality of rods 502 disposed irregularly thereon.

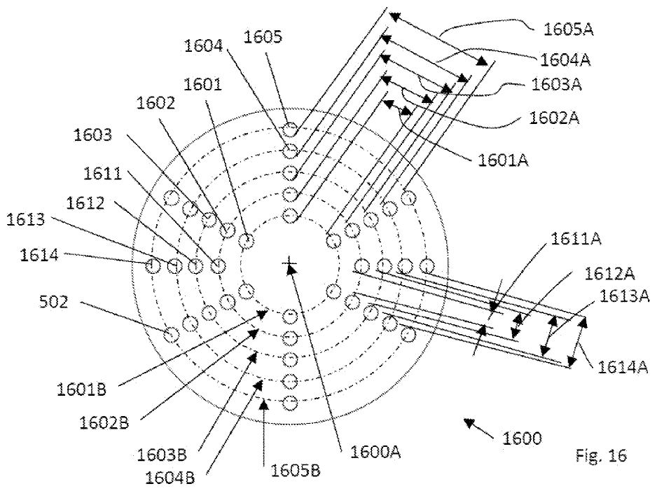

FIG. 16 depicts endplate 1600. Endplate 1600 may include six rod 502 locations equally spaced on various circumferences (e.g., 1601B) and may include additional rod 502 locations 1611,1612, 1613, and 1614 disposed on various circumferences (e.g., 1602B, 1603B, 1604B, 1605B) and separated from each other by 180 degrees.

Rods 502 may be disposed on endplate at locations 1601 such that distance 1601A is established between rods 502. With rods 502 equally spaced from each other and from center point 1600A, a fruit 503 having a minimum width larger than distance 1601A will be well-supported by a cage 101 including two endplates 1600 equipped with rods 502 disposed at locations 1601.

Rods 502 may be disposed on endplate at locations 1602 such that distance 1602A is established between rods 502. Rods 502 may be disposed on endplate at locations 1602 such that distance 1602A is established between rods 502. With rods 502 equally spaced from each other and from center point 1600A, a fruit 503 having a minimum width larger than distance 1602A will be supported by a cage 101 including two endplates 1600 equipped with rods 502 disposed at locations 1602.

Rods 502 may be disposed on endplate 1600 at locations 1603 such that distance 1603A is established between rods 502. With rods 502 equally spaced from each other and from center point 1600A, a fruit 503 having a minimum width larger than distance 1603A will be well-supported by a cage 101 including two endplates 1600 equipped with rods 502 disposed at locations 1603.

Rods 502 may be disposed on endplate at locations 1604 such that distance 1604A is established between rods 502. With rods 502 equally spaced from each other and from center point 1600A, a fruit having a minimum width larger than distance 1604A will be well-supported by a cage 101 including two endplates 1600 equipped with rods 502 disposed at locations 1604.

Rods 502 may be disposed on endplate at locations 1605 such that distance 1605A is established between rods 502. With rods 502 equally spaced from each other and from center point 1600A, a fruit 503 having a minimum width larger than distance 1605A will be well-supported by a cage 101 including two endplates 1600 equipped with rods 502 disposed at locations 1605.

In some embodiments, rods 502 are arranged on endplate 1600 irregularly-for example at one or more of locations 1611, 1612, 1613, 1614—such that the rods 502 are not all equally spaced from each other. In such embodiments, fruit 503 of irregular shape may be well-supported by a cage 101 including two endplates 1600 and a plurality of rods 502 disposed irregularly thereon.

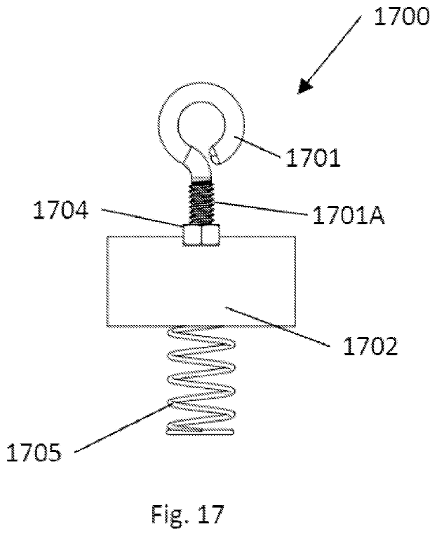

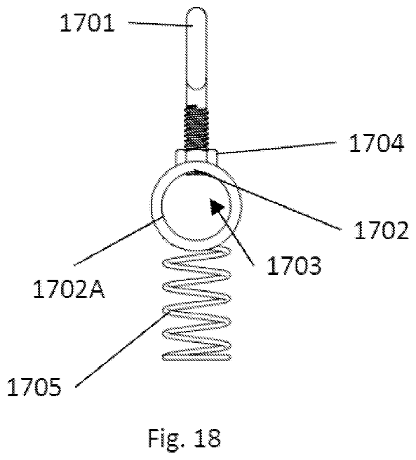

In addition, fruit 503 of different sizes can be supported in the cage 101 during roasting, for example wedge 1700 (shown installed in FIG. 5) may be used to support fruit 503. FIGS. 17 and 18 depict wedge 1700 having a compressible member 1705. In some embodiments, the wedge 1700 is configured to engage with (e.g., slide and clamp onto) rods 502 and or 502A. The wedge 1700 is generally configured to press fruit 503 against rods 502 and or 502A. Wedge 1700 may comprise an eyebolt 1701 attached to a tube 1702. In some embodiments, the eyebolt 1701 is mated with the tube 1702 by a threaded connection. In such embodiments, a thread feature 1701A on the eyebolt 1701 is screwed into a threaded hole 1702A disposed through one side of the tube 1702 and secured by tightening a nut 1704 against the tube 1702. The tube 1702 may include a hole 1703 configured to receive the rod 502 such that the wedge 1700 can slide along rod 502. A user can slide and secure wedge 1700 at a desired location along the rod 502. The user secures the wedge 1700 in place by tightening the eyebolt 1701 such that the threaded feature 1701A contacts the rod 502. In some embodiments, a compressible member 1705 may be attached to tube 1702 and directed toward the fruit 503. In such embodiments, the compressible member 1705 may be a spring configured to press the fruit against the rod 502 and or 502A. The compression member 1705 may be configured to support the fruit 503 as the fruit 503 loses fluid during roasting. Additionally, smaller fruit 503 may be supported by the compression member 1705 such that different size fruit 503 may be roasted along with larger fruit. In other examples, the wedge 1700 may be comprised of any structure configured to be positioned on and fixed to the rod 502 to press fruit 503 against rod 502 and or rod 502A. One of skill in the art will recognize that other compressible member 1705 may be used to press the fruit 503 against the rod 502 and 502A and stabilize (e.g. prevent movement of) the produce 503 during contraction of the fruit 503 during roasting. The rods 502 may be loaded against the product 503 to support the produce 503 during roasting.

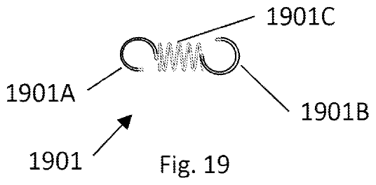

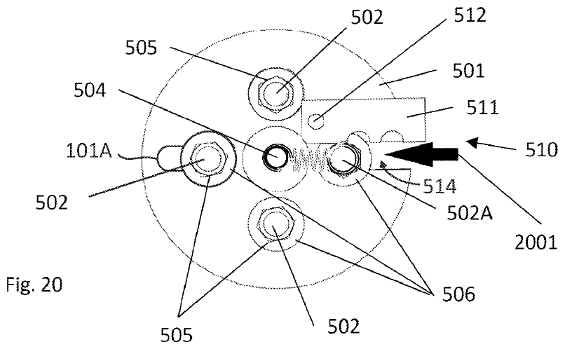

FIGS. 19 and 20 depict a tension spring 1901. The tension spring 1901 includes a first hook 1901A, a second hook 1901B and a coil body 1901C. The first hook 1901A may be attached on to the endplate spindle 504 or on any attachment feature on endplate 501. The second hook 1901B may be attached to the rod 502A as shown in FIG. 20. The coil body 1901C may be configured such that the tension spring 1901 causes a force on the rod 502A in the direction indicated by arrow 2001. FIG. 20 depicts the rod 502A disposed in the gate device 510 which provides clearance for the rod 502A to apply the force from the tension spring 1901 against the produce 503. The force from the tension spring 1901 supports the produce 503 against at least on rod 502 and rod 502A. Additionally, the endplate 501 may include a slot 514 configured to enable the adjustable rod 502A to slide radially away from the endplate spindle 504 against tension force 2001 imparted by the tension spring 1901, and towards the endplate spindle 504 in response to tension force 2001 imparted by the tension spring 1901.

In some embodiments, the cage 101 includes two tension springs 1901. In such embodiments, a first tension spring 1901 is disposed between a first end of the rod 502A and a first end of the endplate spindle 504. The first tension spring 1901 may be disposed outside of the cage 101 (e.g., adjacent the exterior face of the first endplate 501) in some embodiments. In other embodiments, the first tension spring 1901 is disposed inside the cage 101 (e.g., adjacent the interior face of the first endplate 501). The second tension spring 1901 may be disposed between a second end of the rod 502A opposite the first end, and a second end of the endplate spindle 504 opposite the first end. The second tension spring 1901 may be disposed outside of the cage 101 (e.g., adjacent the exterior face of the second endplate 501) in some embodiments. In other embodiments, the second tension spring 1901 is disposed inside the cage 101 (e.g., adjacent the interior face of the second endplate 501). Together, the two tension springs 1901 enable convenient and stable adjustment of the rod 502A radially towards and away from the endplate spindle 504. Adjustment of the rod 502A in this manner enables convenient loading and unloading of fruit 503 from the cage 101 without the need to remove retaining features (e.g., bolts) from the rod 502A. In some embodiments, the tension springs 1901 are configured to enable the rod 502A to be fully removed from the slot 514. In such embodiments, the tension springs 1901 may be configured to pull the rod 502A towards and retain rod 502A against the outer rim of the endplates 501 while fruit 503 is added to or removed from the cage 101.

Tension spring(s) 1901 also conveniently provide tension force 2001 against fruit 503 within the cage 101. For example and without limitation, the tension force 2001 is transferred from the tension spring(s) 1901 to the outer periphery of the fruit 503 within the cage 101 via the rod 502A to secure the fruit 503 (e.g., prevent tumbling or shifting within the cage 101) during roasting.

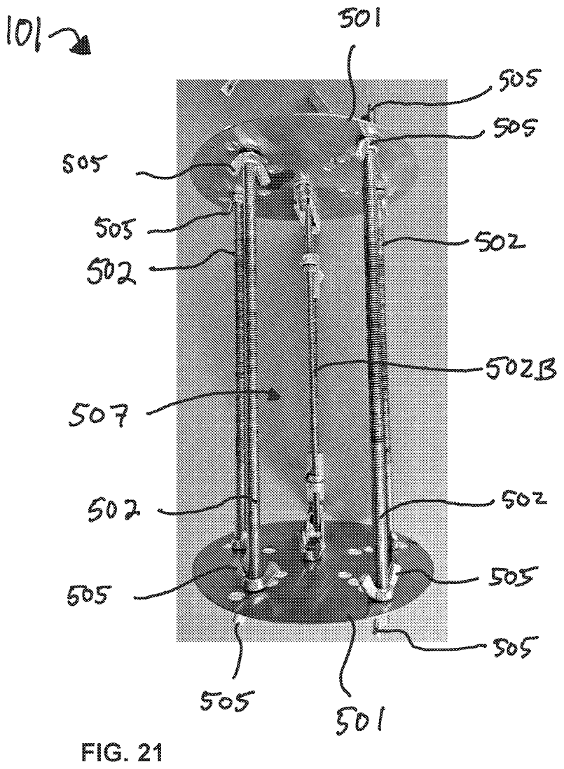

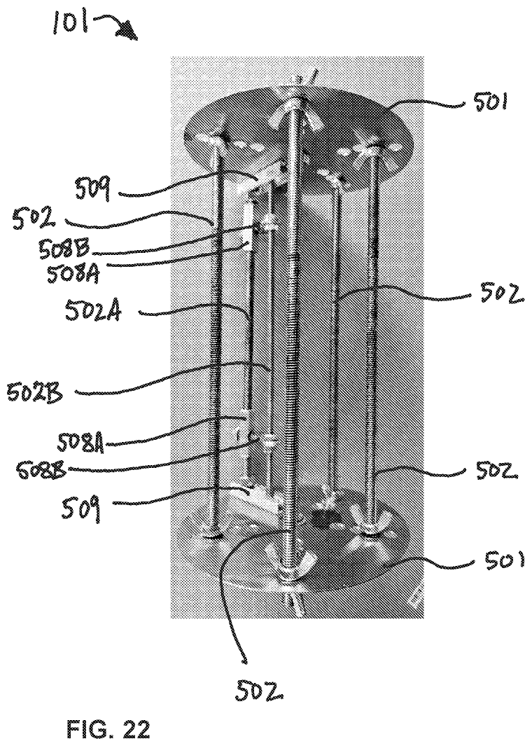

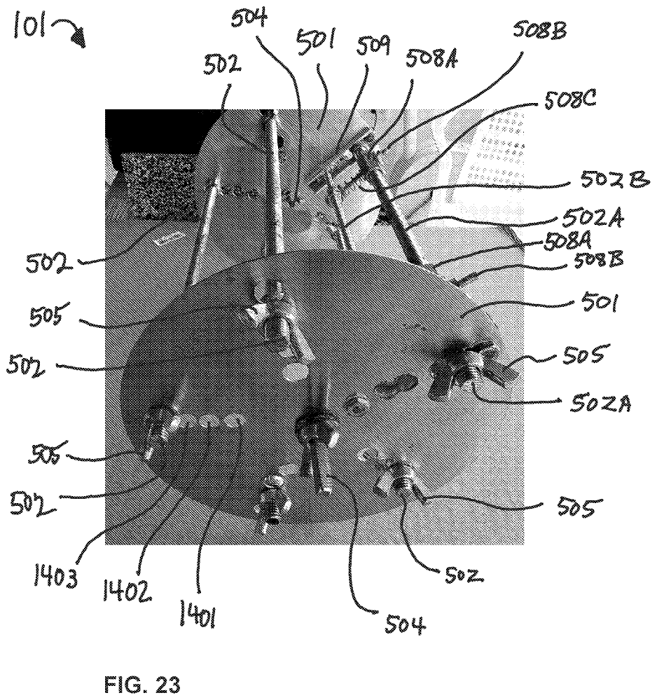

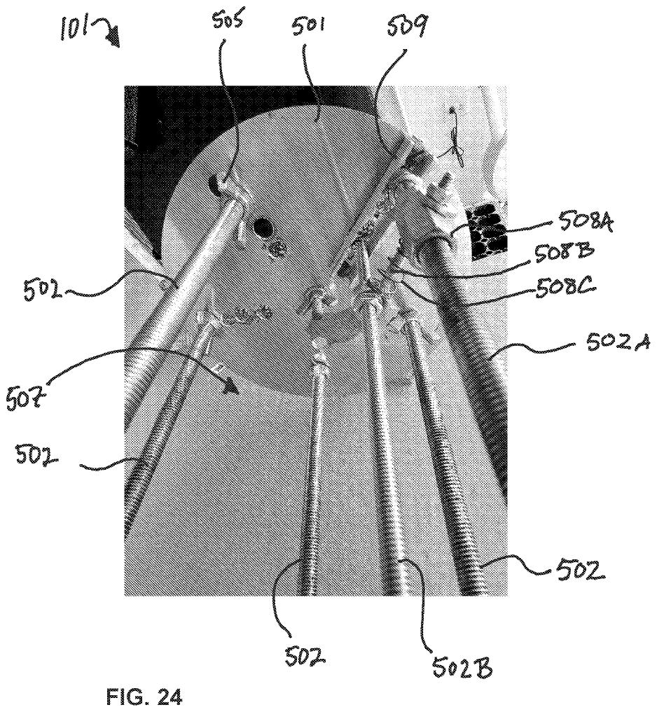

Referring now to FIGS. 21-24, the present disclosure also provides a cage 101 configured to be inserted into and engage with a rotisserie oven, such as a tabletop rotisserie oven (not shown). In general, the cage 101 defines an interior space 507 configured to support the periphery of fruit 503. Cages 101 consistent with the embodiment specifically depicted in FIGS. 21-24 include a plurality of rods 502, 502A, but do not include a wedge 1000. Instead, cages 101 consistent with the embodiment specifically depicted in FIGS. 21-24 include an adjustable rod 502B configured to apply pressure to the outer periphery of fruit 503 placed within the interior space 507.

The cage 101 may include a pair of endplates 501 disposed at opposing ends of the cage 101. Rods 502 are attached to the endplates 501 and are used to support the periphery of fruit 503—in some embodiments the rods 502 contact the periphery of the fruit 503 but do not pierce the periphery of the fruit 503. For example and without limitation, in some embodiments the rods 502 exert force on the periphery of the fruit 503 towards a central axis of the cage 101 extending from the center point of one endplate 501 to the center point of the opposing endplate 501. In some embodiments, the rods 502 are disposed and arranged to lock (e.g., trap, keep, hold) the fruit 503 even as the fruit 503 shrinks during roasting. Rods 502 may be attached to endplates 501 by insertion of each end of each rod 502 into holes 1401, 1402, 1403 in endplates 501 and secured with fasteners 505. Any method of attaching rods 502 to endplates 501 may be used.

In some embodiments, the endplates 501 include one or more channels 509 configured to enable an adjustable rod 502B to be moved towards or away from the central axis of the cage 101, for example to adjust the interior space 507 to accommodate larger or smaller fruit 503, as needed. In the embodiment specifically shown in FIGS. 21-24, each endplate 501 includes only one channel 509. In other embodiments, each endplate 501 may include more than one channel 509, such as two channels 509, three channels 509, four channels 509, or more than four channels 509.

The rods 502 and the endplates 501, in combination, provide an interior space 507 for supporting the periphery of fruit 503. In some examples, rods 502 may be cylindrical or any another cross-sectional geometry such as rectangle, hexagonal, or triangular. Rod 502 only needs a periphery for supporting fruit and ends for attaching to endplates 501. The rods 502 may have any length sufficient to enable the cage 101 to accommodate one or more fruits 503, such as one fruit 503, two fruits 503, three fruits 503, four fruits 503, five fruits 503, or more than five fruits 503.

The adjustable rod 502B may be associated with a non-adjustable rod 502A and is configured to engage with a channel 509 on each endplate 501. In some embodiments, the adjustable rod 502B is configured to apply pressure on the periphery of fruit 503 disposed in the interior space 507. In the embodiment shown in FIGS. 21-24, for example, the adjustable rod 502B is in mechanical communication with the non-adjustable rod 502A via compression springs 508C, which exert force from the non-adjustable rod 502A on the adjustable rod 502B in the direction of the central axis of the cage 101. As fruit 503 in the interior space 507 shrinks while being roasted, the compression springs 508C cause the adjustable rod 502B to move further towards the central axis of the cage 101 to remain in contact with the periphery of the shrinking fruit 503.

In some embodiments, the compression spring 508C is disposed over a guide arm 508B associated with the non-adjustable rod 502A. The guide arm 508B may, in some embodiments, may be affixed to the non-adjustable rod 502A and may be configured to enable the adjustable rod 502B to slide freely over the guide arm 508B in response to the changing length of the compression spring 508C as the fruit 503 in the interior space 503 changes size (e.g., while roasting).

The spindles 504 are configured to mechanically engage with the rotisserie oven to enable the cage 101 to rotate about its central axis in response to the rotisserie oven's motor (not shown).

The present disclosure provides a non-invasive roaster configured to support fruit 503 by supporting the fruit periphery instead of breaching (e.g., piercing) it. As the fruit 503 is roasted it may become soft and shrink. Shrinking fruit 503 has a tendency to fall off a piercing support at least because the lumen through which a supporting rod passes tends to enlarge as fruit loses water content during roasting. In contrast, non-invasive roasting devices consistent with the present disclosure continue to support fruit 503 as roasting causes water loss and contraction at least because the cages 101 are configured to support the roasting fruit 503 about its periphery.

The present disclosure also provides a roasting device that turns (e.g., rotates or continuously rotates) the fruit 503 such that the fruit 503 is more evenly roasted compared to conventional fruit roasting methods.

The present disclosure also provides a roasting device configured to be used with a variety of heat sources including gas, electric, burning wood, or coal. Accordingly, roasting devices consistent with the present disclosure may safely and conveniently be used outside or inside.

In some embodiments, the present disclosure provides an apparatus for roasting a fruit having a periphery, the apparatus comprising: a first endplate and a second endplate; a first rod defining a first end and a second end, the first end of the first rod attached to the first endplate and the second end of the first rod attached to the second endplate; a second rod defining a third end and a fourth end, the third end of the second rod attached to the first endplate and the fourth end of the second rod attached to the second endplate; a third rod defining a fifth end and a sixth end, the fifth end of the third rod attached to the first endplate and the sixth end of the third rod attached to the second endplate; and a fourth rod defining a seventh end and an eighth end, the seventh end of the fourth rod attached to the first endplate and the eighth end of the fourth rod attached to the second endplate, wherein the endplates and rods are configured to support the fruit without piercing the periphery of the fruit. In some embodiments, the apparatus further includes a heating element disposed beneath the endplates and rods. In some embodiments, the apparatus further includes a motor configured to rotate the first endplate and the second endplate. In some embodiments, the apparatus further includes a shell including an openable lid, the shell configured to surround the first endplate, the second endplate, the first rod, the second rod, the third rod, and the fourth rod. In some embodiments, the heating element includes at least one gas burner. In some embodiments, the apparatus further includes a mesh grille disposed beneath the heating element and the rods and configured to support a combustible fuel such as coal, wood, or charcoal. In some embodiments, the apparatus further includes a thermometer configured to determine an internal temperature proximal to the rods. In some embodiments, the apparatus further includes a handle attached to the lid. In some embodiments, the first endplate includes a first plurality of holes, wherein each of the first plurality of holes: is configured to receive one end of the first, second, third, or fourth rod; and is disposed at a first identical distance from a center point of the first endplate. In some embodiments, the first endplate includes a second plurality of holes, wherein each of the second plurality of holes: is configured to receive one end of the first, second, third, or fourth rod; and is disposed at a second identical distance from a center point of the first endplate, wherein the second identical distance is greater than the first identical distance. In some embodiments, the first endplate includes a third plurality of holes, wherein each of the third plurality of holes: is configured to receive one end of the first, second, third, or fourth rod; and is disposed at a third identical distance from a center point of the first endplate, wherein the third identical distance is greater than the second identical distance. In some embodiments, the fruit is breadfruit. In some embodiments, wherein if a diameter of a first breadfruit, and a diameter of a second breadfruit are within a threshold of similarity, both the first breadfruit and the second breadfruit can be roasted at a single time. In some embodiments, the rods each have a length sufficient to accommodate at least one fruit (e.g., one fruit, two fruits, 3 fruits, or more than 3 fruits) between the first and second endplates. In some embodiments, the first endplate and the second endplate each include a movable gate configured to enable the first rod to be easily detached from the first and second endplates (e.g., without tools). In some embodiments, the apparatus further comprises a fifth rod disposed between the first endplate and the second endplate. In some embodiments, the apparatus further comprises a wedge configured to separate the fruit. In some embodiments, the apparatus further comprises a wedge having a compressible member configured to press the fruit against at least one of the first, second, third, or fourth of rods. In some embodiments, the apparatus further comprises a tension spring having a first hook and a second hook, the first hook attached to the first endplate and the second hook attached to the first rod.

In some embodiments, the present disclosure provides a method of roasting breadfruit, the method comprising: attaching a first end of a first rod to a first hole of a first endplate and a second end of the first rod to a first hole of a second endplate; attaching a first end of a second rod to a second hole of the first endplate and a second end of the second rod to a second hole of the second endplate; attaching a first end of a third rod to a third hole of the first endplate and a second end of the third rod to a third hole of the second endplate; attaching a first end of a fourth rod to a fourth hole of the first endplate and a second end of the fourth rod to a fourth hole of the second endplate; inserting one or more breadfruits between the rods; rotating the first and second endplates; and roasting the breadfruit. In some embodiments, the step of inserting the breadfruits does not include piercing skin of the breadfruits with any of the rods. In some embodiments, the method includes; the step of loading at least one rod against the breadfruit with a tension spring. In some embodiments, the step of roasting is complete within about 30 minutes. In some embodiments, the breadfruit is evenly roasted after rotating.

In some embodiments, the present disclosure provides a cage for non-invasively supporting a fruit, the cage comprising: a first endplate including a first plurality of holes disposed equidistantly from its center point by a first distance; a second endplate including a second plurality of holes disposed equidistantly from its center point by the first distance; and a plurality of rods, each rod extending from one of the first plurality of holes in the first endplate to one of the second plurality of holes in the second endplate. In some embodiments, the first endplate further includes a third plurality of holes disposed equidistantly from its center point by a second distance different than the first distance; and the second endplate further includes a fourth plurality of holes disposed equidistantly from its center point by the second distance. In some embodiments, the first endplate further includes a fifth plurality of holes disposed equidistantly from its center point by a third distance different than the first and second distances; and the second endplate further includes a sixth plurality of holes disposed equidistantly from its center point by the third distance. In some embodiments, the first endplate includes a first rotatable gate configured to enable enlargement or constriction of at least one of the first plurality of holes in the first endplate; and the second endplate includes a second rotatable gate configured to enable enlargement or constriction of at least one of the second plurality of holes in the second endplate. In some embodiments, the first endplate includes a first rotatable gate configured to enable enlargement or constriction of at least one of the first plurality of holes in the first endplate and at least one of the third plurality of holes in the first endplate; and the second endplate includes a second rotatable gate configured to enable enlargement or constriction of at least one of the second plurality of holes in the second endplate and at least one of the fourth plurality of holes in the second endplate. In some embodiments, the first endplate includes a first rotatable gate configured to enable enlargement or constriction of at least one of the first plurality of holes in the first endplate, at least one of the third plurality of holes in the first endplate, and at least one of the fifth plurality of holes in the first endplate; and the second endplate includes a second rotatable gate configured to enable enlargement or constriction of at least one of the second plurality of holes in the second endplate, at least one of the fourth plurality of holes in the second endplate, and at least one of the sixth plurality of holes in the second endplate. In some embodiments, the cage is configured to be rotated about an axis defined by the center point of the first endplate and the center point of the second endplate. In some embodiments, the cage includes a wedge configured to separate the fruit. In some embodiments, the cage includes a wedge having a compressible member configured to press the fruit against at least one of the plurality of rods. In some embodiments, the cage further comprises a tension spring having a first hook and a second hook, the first hook attached to the first endplate and the second hook attached to the first rod. In some embodiments, the cage includes an adjustable rod configured to move towards a central axis of the cage to remain in contact with the fruit as the fruit changes in size. In some embodiments, the adjustable rod is configured to move towards the central axis of the cage along a first channel associated with the first endplate and along a second channel associated with the second endplate. In some embodiments, the adjustable rod is associated with one of the plurality of rods. On some embodiments, a compression spring exerts a spring force between the adjustable rod and the one of the plurality of rods.

In some embodiments, the present disclosure provides an apparatus for roasting a fruit having a periphery, the apparatus comprising: a first endplate and a second endplate; and a plurality of rods each having a first and second end, the plurality of rods attached to the first endplate at the first end and the second end of the plurality of rods attached to the second endplate, wherein the endplates and rods are configured to support the fruit without piercing the periphery of the fruit. In some embodiments, at least one endplate includes a spindle configured to support the at least one endplate. In some embodiments, the spindle is rotationally supported by a bearing. In some embodiments, the apparatus includes a motor with motor shaft attached to the spindle configured to move the first endplate and second endplate and the plurality of rods. In some embodiments, the apparatus further comprises a wedge configured to separate the fruit. In some embodiments, the apparatus further comprises a wedge having a compressible member configured to press the fruit against at least one the plurality of rods. In some embodiments, the apparatus further comprises a tension spring having a first hook and a second hook, the first hook attached to the first endplate and the second hook attached to a first end of the first rod. In some embodiments, the apparatus further comprises a second tension spring having a first hook and a second hook, the first hook attached to the second endplate and the second hook attached to a second end of the first rod opposite the first end.

Methods of evenly roasting produce, such as breadfruit, are provided herewith. Generally, produce 503 (e.g., breadfruit) to be roasted is secured in a cage 101 of a non-invasive roasting device 100 using a plurality of rods 502 arranged between two endplates 501. The cage 101 is rotated within a shell 102 while heat is applied to the produce 503 from a heat source 111.

As used herein, labels such as “first,” “second,” and “third” do not specify any priority, but are merely descriptors for clarity. An object may be a first object in a first example, and may be re-labeled as a third object in a second example.

1. An apparatus for roasting a fruit having a periphery, the apparatus comprising:
a first endplate and a second endplate;
a first rod defining a first end and a second end, the first end of the first rod attached to the first endplate and the second end of the first rod attached to the second endplate;
a second rod defining a third end and a fourth end, the third end of the second rod attached to the first endplate and the fourth end of the second rod attached to the second endplate; and
a third rod defining a fifth end and a sixth end, the fifth end of the third rod attached to the first endplate and the sixth end of the third rod attached to the second endplate, wherein the endplates and rods support the fruit for rotation therewith without tumbling of the fruit relative to the endplates, and without piercing the periphery of the fruit.

2. The apparatus of claim 1, further comprising at least one of:
a heating element disposed beneath the endplates and rods;
a motor configured to rotate the first endplate and the second endplate;
a shell including an openable lid, the shell configured to surround the first endplate, the second endplate, the first rod, the second rod, and the third rod; and
a thermometer configured to determine an internal temperature proximal to the rods.

3. The apparatus of claim 1, further comprising a motor configured to rotate the first endplate and the second endplate, wherein the rotation of the first endplate and the second endplate results in the rotation of the first rod, the second rod, and the third rod.

4. The apparatus of claim 1, further comprising a shell configured to surround the first endplate, the second endplate, the first rod, the second rod, and the third rod, wherein the shell is stationary during rotation of the first endplate, the second endplate, the first rod, the second rod, and the third rod.

5.-8. (canceled)

9. The apparatus of claim 1, wherein the first endplate includes a first plurality of holes, wherein each of the first plurality of holes:
is configured to receive one end of the first, second, or third rod; and
is disposed at a first identical distance from a center point of the first endplate; and wherein each of the second plurality of holes:
is configured to receive the one end of the first, second, or third rod; and
is disposed at a second identical distance from the center point of the first endplate, wherein the second identical distance is greater than the first identical distance.

10. The apparatus of claim 9, wherein the second endplate includes a third plurality of holes, wherein each of the third plurality of holes:
is configured to receive an opposite end of the first, second, or third rod.

11. (canceled)

12. The cage of claim 25, wherein the fruit is breadfruit.

13.-17. (canceled)

18. The apparatus of claim 1, further comprising a compressible member to press the fruit against at least one of the first rod, the second rod, or the third rod.

19. (canceled)

20. A method of roasting breadfruit, the method comprising:
attaching a first end of a first rod to a first hole of a first endplate and a second end of the first rod to a first hole of a second endplate;
attaching a first end of a second rod to a second hole of the first endplate and a second end of the second rod to a second hole of the second endplate;
attaching a first end of a third rod to a third hole of the first endplate and a second end of the third rod to a third hole of the second endplate;
inserting one or more breadfruits between the rods;
rotating the first and second endplates, wherein the endplates and the rods rotate the breadfruit relative therewith; and
roasting the breadfruit without piercing the skin of the breadfruit with any of the rods.

21.-23. (canceled)

24. The method of claim 20 further comprising loading at least one rod against the breadfruit with at least one tension spring.

25. A cage for non-invasively supporting a fruit, the cage comprising:
a first endplate including a first center point, a first plurality of holes disposed equidistantly from the first center point by a first distance;
a second endplate including a second center point, a second plurality of holes disposed equidistantly from the second center point by the first distance; and
a plurality of rods, each rod extending from one of the first plurality of holes in the first endplate to one of the second plurality of holes in the second endplate; and
at least one adjustable rod configured to move towards a central axis of the cage to remain in contact with the fruit as the fruit changes in size.

26. The cage of claim 25, wherein:
the first endplate further includes a third plurality of holes disposed equidistantly from the first center point by a second distance different than the first distance; and
the second endplate further includes a fourth plurality of holes disposed equidistantly from the second center point by the second distance.

27. The cage of claim 26, wherein:
the first endplate further includes a fifth plurality of holes disposed equidistantly from the first center point by a third distance different than the first and second distances; and
the second endplate further includes a sixth plurality of holes disposed equidistantly from the second center point by the third distance.

28. The cage of claim 26, wherein:
the first endplate includes a first rotatable gate configured to enable enlargement or constriction of at least one of the first plurality of holes in the first endplate; and
the second endplate includes a second rotatable gate configured to enable enlargement or constriction of at least one of the second plurality of holes in the second endplate.

29.-30. (canceled)

31. The cage of claim 25, wherein the cage is configured to be rotated about an axis defined by the first center point of the first endplate and the second center point of the second endplate.

32.-35. (canceled)

36. The cage of claim 25, wherein the at least one adjustable rod is configured to move towards the central axis of the cage along a first channel associated with the first endplate and along a second channel associated with the second endplate.

37. (canceled)

38. The cage of claim 25, further comprising a spring, the spring to exert a spring force between the at least one adjustable rod and the one of the plurality of rods.

39.-45. (canceled)

46. The cage of claim 25, wherein the cage is inserted in a tabletop rotisserie oven.

47. The apparatus of claim 1, wherein the first endplate and the second endplate define a central axis, the apparatus further comprising an adjustable rod, the adjustable rod configured to move towards the central axis to remain in contact with the fruit as the fruit changes in size during roasting.

48. The method of claim 20, wherein the third rod is an adjustable rod moveable to remain in contact with the breadfruit as the breadfruit changes in size during the roasting of the breadfruit.
